(19) United States
(12) Patent Application Publication
(10) Pub. No.: US 2022/0234920 A1
(43) Pub. Date: Jul. 28, 2022

(54) METHOD OF REMOVING CONTAMINATE IN WASTEWATER

(71) Applicant: PHILLIPS 66 COMPANY, Houston, TX (US)

(72) Inventors: Xiangxin Yang, Bartlesville, OK (US); John M. Novak, Ponca City, OK (US); Wayne A. Duvall, JR., Tonkawa, OK (US)

(73) Assignee: PHILLIPS 66 COMPANY, Houston, TX (US)

(21) Appl. No.: 17/572,127

(22) Filed: Jan. 10, 2022

Related U.S. Application Data
(60) Provisional application No. 63/141,603, filed on Jan. 26, 2021.

(51) Int. Cl. C02F 1/70; C02F 1/66; C02F 3/12

(52) U.S. Cl. CPC C02F 1/705; C02F 2101/106; C02F 3/12; C02F 1/66

(57) ABSTRACT

A method of removing or reducing the concentration of a contaminant in wastewater. The method involves combining wastewater and an elemental iron, comprising of zero valent iron, in a tank to produce treatment water. In this method the wastewater contains a contaminant consisting of: selenate [Se(VI)], selenite [Se(IV)], selenocyanate [SeCN⁻¹], selenide [Se(−II)], and combinations thereof. The treatment water is then agitated with mechanical mixing and air sparging to produce a treated slurry. The treated slurry is then separated into a treated water stream and a contaminate stream.

### CROSS-REFERENCE TO RELATED APPLICATIONS

This application is a non-provisional application_which claims the benefit of and priority to U.S. Provisional Application Ser. No. 63/141,603 filed Jan. 26, 2021, entitled “Method of Removing Contaminate in Wastewater,” which is hereby incorporated by reference in its entirety.

### STATEMENT REGARDING FEDERALLY SPONSORED RESEARCH OR DEVELOPMENT

None.

### FIELD OF THE INVENTION

This invention relates to a method of removing or reducing the concentration of a contaminant in wastewater

### BACKGROUND OF THE INVENTION

Wastewater treatment is one of the most important and challenging environmental problems associated with energy generation. Cost-effective and reliable technologies capable of treating such complicated wastewater are in demand. Specifically, selenium is present in a variety of industry wastewaters and is increasingly recognized as a pollutant of significant concern. In recent years, both federal and local environmental regulatory bodies have moved towards imposing strict limits for selenium concentrations in industrial effluent discharges. In industrial wastewaters, selenium may be present in various forms.

Removing selenium from wastewater represents a challenge and a mandate to the water industry, particularly selenium since selenium can be found in various forms. Others have tried to address this issue by using methods such as iron coprecipitation, namely adding ferric salt to the wastewater and adjusting pH to precipitate ferric hydroxide and promote ferric hydroxide particle grown for the sorption of selenium. Another method people have tried is using elemental iron to reduce Se(VI) and Se(IV) to elemental selenium. Additionally, other methods have also tried biological treatment by using anaerobic bacteria to convert Se(VI) and Se(IV) to elemental selenium as part of a metabolism process based on selenium respiration.

In a more detailed example, an activated sludge process is an example of a biological process that can be used for wastewater treatment, including groundwater remediation. Activated sludge process takes advantage of micro-organisms that can digest organic matter and clump together by flocculation and produces a liquid that is relatively free from suspended solids and organic material. Flocculated particles will readily settle out and can be removed. The general arrangement of an activated sludge process includes an aeration tank where air is injected in the mixed liquor, followed by a settling tank (referred to as clarifier) to allow biological flocks to settle, thus separating the biological sludge from the clear treated water.

Selenium usually exists in four oxidation states: selenate [Se(VI)], selenite [Se(IV)], elemental selenium [Se(O)], and selenide [Se(−II)]. The speciation is an important factor since the treatment efficiency usually depends on the oxidation state. Typical iron coprecipitation selenium removal process in wastewater activated sludge unit is shown in FIG. 1. In the first step, selenocyanate in the wastewater is converted to Se(IV) and/or Se(VI) by oxidation with aerobic biological treatment in the activated sludge unit. Subsequently, selenium is removed by the iron hydroxide adsorbent, which is formed by the precipitation of iron salt. Due to the different adsorption kinetics of Se(IV) versus Se(VI) in the coprecipitation process, the oxidation step should be controlled carefully to minimize the formation of Se(VI) since Se(IV) has a strong affinity for the iron hydroxide adsorbent, whereas Se(VI) does not. The efficiency of this process can be affected by the competitive adsorption from other contaminants in the wastewater such as sulfate, which is more concentrated than selenium by 2 to 3 orders of magnitude. Additionally, the efficiency of this process can also be impaired by large amounts of organic contaminants characterized by chemical oxygen demand in the wastewater.

All of the current methods for removing selenium from wastewater have relatively low efficiency rates. There exists a need for a method to remove selenium from wastewater at higher efficiency rates than conventional methods.

### BRIEF SUMMARY OF THE DISCLOSURE

A method of removing or reducing the concentration of a contaminant in wastewater. The method involves combining wastewater and an elemental iron, comprising of zero valent iron, in a tank to produce treatment water. In this method the wastewater contains a contaminant consisting of: selenate [Se(VI)], selenite [Se(IV)], selenocyanate [SeCN⁻¹], selenide [Se(−II)], and combinations thereof. The treatment water is then agitated with mechanical mixing and air sparging to produce a treated slurry. The treated slurry is then separated into a treated water stream and a contaminate stream.

A method of removing or reducing the concentration of a contaminant in wastewater. The method involves combining wastewater and an elemental iron, comprising of zero valent iron, in a tank to produce treatment water. In this method the wastewater contains a contaminant consisting of: selenate [Se(VI)], selenite [Se(IV)], selenocyanate [SeCN⁻¹], selenide [Se(−II)], and combinations thereof. The treatment water is then agitated with mechanical mixing and air sparging to produce an initial treated slurry. The initial treated slurry is then transferred to an active sludge unit where it is treated with an initial acid and a second elemental iron, comprising of zero valent iron, to produce a second treated slurry. The second treated slurry is then transferred to a clarifier to separate the second treated slurry into a third treated slurry and a contaminate stream. Lastly, the third treated slurry is then transferred to a tank to be treated with a secondary acid and a third elemental iron, comprising of zero valent iron, to produce a treated water.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a conventional contaminants removal system.

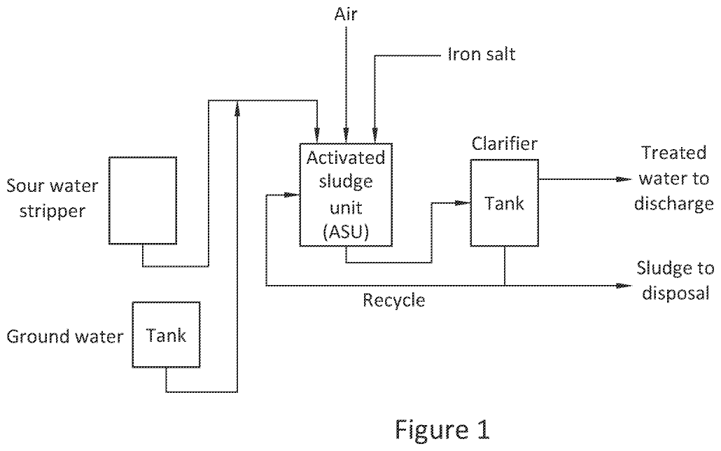

FIG. 2 depicts a method of removing or reducing the concentration of a contaminant in wastewater.

FIG. 3 depicts a removing or reducing the concentration of a contaminant in wastewater

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

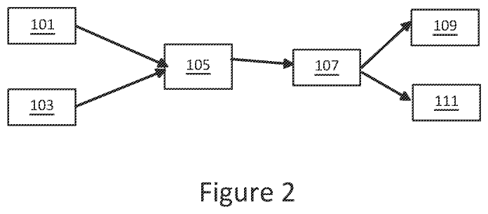

A method, as shown in FIG. 2, of removing or reducing the concentration of a contaminant in wastewater. The method involves combining wastewater 101 and an elemental iron 103, comprising of zero valent iron, in a tank to produce treatment water 105. In this method the wastewater contains a contaminant consisting of: selenate [Se(VI)], selenite [Se(IV)], selenocyanate [SeCN⁻¹], selenide [Se(−II)], and combinations thereof. The treatment water is then agitated with mechanical mixing and air sparging to produce a treated slurry 107. The treated slurry is then separated into a treated water stream 109 and a contaminate stream 111.

In one embodiment the size of the zero valent iron is greater than 100 μm or even greater than 200 μm. In yet another embodiment, the size of the zero valent iron is from about 100 μm to about 500 μm or from about 200 μm to about 500 μm.

The following examples of certain embodiments of the invention are given. Each example is provided by way of explanation of the invention, one of many embodiments of the invention, and the following examples should not be read to limit, or define, the scope of the invention.

### EXAMPLE 1

In Example 1, wastewater from any known conventional source such as a sour water stripper, contaminated water from processing units, or groundwater from remediation wells is treated. In this example the wastewater stream can contain a contaminant consisting of: selenate [Se(VI)], selenite [Se(IV)], selenocyanate [SeCN⁻¹], selenide [Se(−II)]. Zero valent iron in the form of (Fe(O)) particles, ferrous iron (Fe2+), ferric iron (Fe3+), can then be added to the wastewater to produce a treatment water. Mechanical mixing and air sparging with conventional air are then done to the treatment water to produce a treated slurry. Optionally, an acid can be added such as hydrochloric acid, nitric acid, sulfuric acid, or combinations thereof to lower the pH of the treatment water to a range of about 6 to 8. This treated slurry can then be separated into a treated water stream and a contaminate stream.

### EXAMPLE 2

In Example 2, wastewater from any known conventional source such as a sour water stripper, contaminated water from processing units, or groundwater from remediation wells is treated in an activated sludge unit. In a non-limiting embodiment, treated slurry or a contaminate stream from Example 1 can also be treated. In this example the wastewater stream can contain a contaminant consisting of: selenate [Se(VI)], selenite [Se(IV)], selenocyanate [SeCN⁻¹], selenide [Se(−II)]. Zero valent iron in the form of (Fe(O)) particles, ferrous iron (Fe2+), ferric iron (Fe3+), and ferric hydroxide can then be added to the wastewater to produce a treatment water. Mechanical mixing and air sparging with conventional air are then done to the treatment water to produce a treated slurry. Optionally, an acid can be added such as hydrochloride acid, hydrochloric acid, nitric acid, sulfuric acid, or combinations thereof to lower the pH of the treatment water to a range of about 6 to 8. This treated slurry can then be sent to a clarifier to be separated into a treated water stream and a contaminate stream.

### EXAMPLE 3

In Example 3, previously treated wastewater can be treated in a tank. In this example the wastewater stream can contain a contaminant consisting of: selenate [Se(VI)], selenite [Se(IV)], selenocyanate [SeCN⁻¹], selenide [Se(−II)]. Zero valent iron in the form of (Fe(O)) particles, ferrous iron (Fe2+), ferric iron (Fe3+), can then be added to the wastewater to produce a treatment water. Mechanical mixing and air sparging with conventional air are then done to the treatment water to produce a treated slurry. Optionally, an acid can be added such as hydrochloride acid, hydrochloric acid, nitric acid, sulfuric acid, or combinations thereof to lower the pH of the treatment water to a range of about 6 to about 8. In this embodiment, the treated slurry has no additional contaminate stream and can be directly discharged as treated water.

### EXAMPLE 4

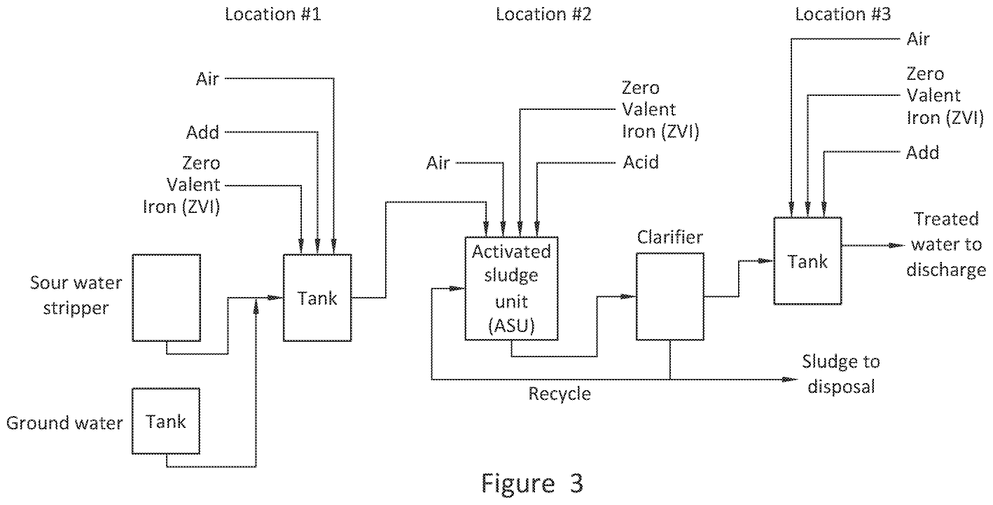

In Example 4, as shown in FIG. 3, wastewater from any known conventional source 201 such as a sour water stripper, contaminated water from processing units, or groundwater from remediation wells is treated in a tank 203. In this example the wastewater stream can contain a contaminant consisting of: selenate [Se(VI)], selenite [Se(IV)], selenocyanate [SeCN⁻¹], selenide [Se(−II)]. Zero valent iron 205 in the form of (Fe(O)) particles, ferrous iron (Fe2+), ferric iron (Fe3+ can then be added to the wastewater to produce a treatment water. Mechanical mixing and air sparging 207 with conventional air are then done to the treatment water to produce an initial treated slurry. Optionally, an acid 209 can be added such as hydrochloride acid, hydrochloric acid, nitric acid, sulfuric acid, or combinations thereof to lower the pH of the treatment water to a range of about 6 to about 8.

It is theorized that in this first step elemental iron plays a central role in deselenation of selenocyanate (SeCN—). Both Fe2+ and Fe3+ ions are formed in the presence of dissolved oxygen and then iron cyanide precipitates are formed, which likely promotes the deselenation reaction.

The initial treated slurry is then directly transferred to an active sludge unit 211. At the active sludge unit, a second elemental iron 213, comprising of a zero valent iron in the form of (Fe(O)) particles, ferrous iron (Fe2+), ferric iron (Fe3+), can then be added to the wastewater to produce a treatment water. Mechanical mixing and air sparging 215 with conventional air are then done to the treatment water to produce a second treated slurry. Optionally, an acid 217 can be added such as hydrochloride acid, hydrochloric acid, nitric acid, sulfuric acid, or combinations thereof to lower the pH of the treatment water to a range of about 6 to about 8. This treated slurry can then be sent to a clarifier 219 to be separated into a third treated slurry 221 and a contaminate stream 223. The contaminate stream is sent back to the active sludge unit.

It is theorized in this second step that SeCN— is oxidized to Se(IV) and Se(VI) by micro-organisms. Through electrochemical reduction, elemental iron converts Se(VI) to Se(IV) and/or Se(O). Fe3+ ions are formed by dissolved oxygen and/or microorganisms and then Se(IV) can be absorbed onto the solid surface of iron hydroxide particles and become surface-bound selenium and then settle out. In the activated sludge unit, elemental iron can act as the sacrificial agent for Se(IV) and/or oxygen scavenger to lower the dissolved oxygen level in the bioreactor to reduce the activity of micro-organisms. In both ways, it can help preserve Se(IV) and depress its further oxidation to Se(VI). Therefore, possibly a higher Se(IV)/Se(VI) ratio was obtained, resulting in high efficiency for selenium removal.

Lastly the third treated slurry is transferred into a tank 225 to be treated with a secondary acid 227 and a third elemental iron 229, comprising of zero valent iron. Zero valent iron in the form of (Fe(O)) particles, ferrous iron (Fe2+), ferric iron (Fe3+), and ferric hydroxide can then be added to the wastewater to produce a treatment water. Mechanical mixing and air sparging 231 with conventional air are then done to the treatment water to produce a treated water. Optionally, an acid 233 can be added such as hydrochloride acid, hydrochloric acid, nitric acid, sulfuric acid, or combinations thereof to lower the pH of the treatment water to a range of about 6 to about 8. In this embodiment, the treated slurry has no additional contaminate stream and can be directly discharged as treated water 235.

It is theorized that in this third step all of the selenium is in the form of Se(VI) and its level is much lower if there is any selenium removal treatment upstream. It is also theorized that principal mechanism of selenium removal is reduction by the elemental iron. For elemental iron, the surface condition can strongly influence its reactivity since a smaller particle size means a higher surface area and more active sites available for reactions. Therefore, the system performance can be affected by its particle size due to the various roles of elemental iron in this system. Extra acid such as hydrochloride acid is added to facilitate the reaction. The acid helps remove the dense layer of iron oxide on the surface and promotes the reaction between elemental iron and selenium. The surface charge is positive for iron hydroxide adsorbent at low to neutral pH, so anions such as Se (IV) are adsorbed. Therefore, it is anticipated that the addition of acid helps the removal of selenium.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of removing or reducing the concentration of a contaminant in wastewater, comprising:
(a) combining wastewater and an elemental iron, comprising of zero valent iron, in a tank to produce treatment water, wherein the wastewater contains a contaminant consisting of: selenate [Se(VI)], selenite [Se(IV)], selenocyanate [SeCN⁻¹], selenide [Se(−II)], and combinations thereof;
(b) agitating through mechanical mixing and air sparging the treatment water to produce a treated slurry;
(c) separating the treated slurry into a treated water stream and a contaminate stream.

2. The method of claim 1, wherein the size of the zero valent iron is greater than 100 μm.

3. The method of claim 1, wherein the elemental iron comprises a solution of zero valent iron selected from the group consisting of: Fe(O) particles, ferrous iron (Fe²⁺), ferric iron (Fe³⁺), or combinations thereof.

4. The method of claim 1, wherein the wastewater comes from a sour water stripper.

5. The method of claim 1, wherein the method does not utilize a fluidized bed.

6. The method of claim 1, wherein the contaminate stream is recycled back into the tank to be treated again.

7. The method of claim 1, wherein an acid is added to the tank.

8. The method of claim 7 wherein the acid is selected from the group consisting of: hydrochloric acid, nitric acid, sulfuric acid, or combinations thereof.

9. The method of claim 1, wherein the treatment water has a pH from about 6 to about 8.

9. A method of removing or reducing the concentration of a contaminant in wastewater, comprising:
(a) combining wastewater and an elemental iron, comprising of zero valent iron, in a tank to produce treatment water, wherein the wastewater contains a contaminant consisting of: selenate [Se(VI)], selenite [Se(IV)], selenocyanate [SeCN⁻¹], selenide [Se(−II)], and combinations thereof;
(b) agitating through mechanical mixing and air sparging the treatment water to produce an initial treated slurry;
(c) transferring the initial treated slurry to an active sludge unit where it is treated with an initial acid and a second elemental iron, comprising of zero valent iron, to produce a second treated slurry;
(d) transferring the second treated slurry to a clarifier to separate the second treated slurry into a third treated slurry and a contaminate stream;
(e) transferring the third treated slurry to a tank to be treated with a secondary acid and a third elemental iron, comprising of zero valent iron, to produce a treated water.
